(19) United States
(12) Patent Application Publication
(10) Pub. No.: US 2023/0306076 A1
(43) Pub. Date: Sep. 28, 2023

(54) SPATIAL PREDICTION METHOD OF RICE STABLE ISOTOPE BASED ON ENVIRONMENTAL SIMILARITY

(71) Applicant: Zhejiang Academy of Agricultural Sciences, Hangzhou (CN)

(72) Inventors: Yuwei Yuan, Hangzhou (CN); Meiling Sheng, Hangzhou (CN); Chunlin Li, Hangzhou (CN); Yongzhi Zhang, Hangzhou (CN); Jing Nie, Hangzhou (CN); Shengzhi Shao, Hangzhou (CN)

(73) Assignee: Zhejiang Academy of Agricultural Sciences, Hangzhou (CN)

(21) Appl. No.: 18/127,063

(22) Filed: Mar. 28, 2023

(30) Foreign Application Priority Data
Mar. 28, 2022 (CN) 202210313603.1

(51) Int. Cl. G06F 17/12; G01N 1/16

(52) U.S. Cl. CPC G06F 17/12; G01N 1/16

(57) ABSTRACT

A spatial prediction method of rice stable isotope based on environmental similarity is provided. The method comprises: describing environmental characteristics of the rice stable isotope; measuring an environmental similarity between a site to be predicted and a sample site; measuring a reliability of the sample site; and carrying out a spatial prediction on the rice stable isotope according to the environmental similarity between the site to be predicted and the sample site and the reliability of the sample site. This method can improve the accuracy of the prediction result.

### CROSS-REFERENCE TO RELATED APPLICATION

This patent application claims the benefit and priority of Chinese Patent Application No. 202210313603.1 filed with the China National Intellectual Property Administration on Mar. 28, 2022, the disclosure of which is incorporated by reference herein in its entirety as part of the present application.

### TECHNICAL FIELD

The present disclosure relates to the field of spatial prediction of food stable isotope, in particular to a spatial prediction method of rice stable isotope based on environmental similarity.

### BACKGROUND

A Kriging interpolation method is one of the most representative methods in spatial prediction of stable isotope. The prediction method based on spatial autocorrelation is to statistically analyze a stable isotope value of a sample site and the spatial position of a sample site, establish a spatial autocorrelation model for describing the stable isotope, apply the established prediction model to the whole prediction region, and predict the stable isotope value by combining the spatial position of the site to be predicted. However, this method only considers the influence of the spatial position, without considering the influence of other natural factors on the stable isotope. At present, a regression-geostatistical method has been widely used. This method uses the environmental factors that influence the stable isotope and the stable isotope to establish a regression model, and then uses Kriging to interpolate the residual. Finally, the results of the regression model are combined with the results of the residual interpolation to predict the whole region.

The above two methods require that the sample site is globally representative and the established prediction relationship is globally applicable, which is unreasonable in practice, especially in large-scale areas with complex terrain, and may greatly affect the accuracy of the prediction result.

### SUMMARY

The present disclosure aims to overcome the shortcomings of the prior art, and provides a spatial prediction method of rice stable isotope based on environmental similarity, which can get rid of the requirements of global representation of the sample site and global applicability of the prediction relationship and improve the accuracy of the prediction result.

According to the present disclosure, there is provided a spatial prediction method of rice stable isotope based on environmental similarity, where the method comprises:
(1) screening factors that have great influence on the rice stable isotope as auxiliary variables in prediction process;
(2) calculating a similarity for a single factor between the site to be predicted and the sample site by using a Gower similarity calculation method, and synthesizing similarity for each influencing factor by using a weighted average method to obtain a value of the environmental similarity between the site to be predicted and the sample site;
(3) calculating the reliability of the sample site by using an environmental similarity between sample sites and a similarity for a target variable; and
(4) carrying out a spatial prediction on the rice stable isotope according to the environmental similarity between the site to be predicted and the sample site and the reliability of the sample site.

Preferably, step (2) specifically comprises: calculating the environmental similarity for the single factor by using a Gower similarity calculation method, which is expressed as:

$$E ( {c}_{vi} , {e}_{vj} ) = 1 - \frac{\vert {e}_{vi} - {e}_{vj} \vert}{Range ( v )}$$

where E(·) is a function used to calculate a similarity of a single environmental variable; eᵥᵢ and eᵥⱼ are characteristics of the v-th environmental variable at site i and site j, respectively; and Range(v) represents a range of the v-th environment variable.

The environmental similarity between the site to be predicted and the sample site is synthesized by using the weighted average method, and the calculation formula is as follows:

$${S}_{ij} = \frac{a * E ( {e}_{1 i} , {e}_{1 j} ) + b * E ( {e}_{2 i} , {e}_{2 j} ) + , … , + n * E ( {e}_{mi} , {e}_{mj} )}{a + b + … + n} ,$$

where Sᵢⱼ is an environmental similarity between site i and site j, and a, b . . . n are the weights of various environmental factors; and eᵥᵢ and eᵥⱼ are the characteristics of the v-th environmental variable at site i and site j, respectively.

Preferably, in step (3), the calculation of the reliability of the sample site comprises:

determining the relationship between the sample sites according to the environmental similarity between the sample sites and the similarity of target variables, where the more supporting sample sites are, the higher the reliability is; the more contradictory sample sites are, the lower the reliability is; if the sample site has only a contradictory sample site but no a supporting sample site, the reliability of the sample site is 0; and if there is neither a supporting sample site nor a contradiction site, the reliability of the site is unknown, which is set to a null value “NoData”. The calculation formula of the reliability of the sample site is as follows:

$${r}_{i} = \{ \begin{matrix}\frac{{\sum }_{k = 1}^{{n}_{s}} {TS}_{i , k}}{{n}_{s}} \times \frac{{n}_{s}}{{n}_{s} + {n}_{c}} , {n}_{s} + {n}_{c} > 0 and {n}_{s} \neq 0 \\ 0 , {n}_{c} > 0 and {n}_{s} = 0 \\ NoData , {n}_{s} + {n}_{c} = 0\end{matrix} ,$$

where rᵢ refers to a reliability of a sample site i; nₛ and n_{c} represent a number of supporting sample sites and a number of contradictory sample sites for the sample site i, respectively; TS_{i,k} is based on the similarity for the target variable between the sample site i and the supporting sample site.

Preferably, in step (4), calculating a stable isotope value of the site to be predicted based on steps (2) and (3) comprises: calculating a value of each site to be predicted by using the weighted average method, and a formula is as follows:

$${V}_{j} = \frac{{\sum }_{i = 1}^{{n}^{′}} {S}_{ji} \times {V}_{i}}{{\sum }_{i = 1}^{{n}^{′}} {S}_{ji}} ,$$

where n′ is a number of sample sites satisfying a prediction condition, and Sⱼᵢ is an environmental similarity between a site to be predicted j and a sample site i; and Vᵢ is a target variable value of the sample site i (the stable isotope value).

The calculation formula of an uncertainty of the prediction is as follows:

Uⱼ=1−max(Sⱼᵢ×r₁,Sⱼ₂×r₂, . . . ,Sⱼₙ×rₙ).

where n is a number of sample sites, and Sⱼₙ is a environmental similarity of a sample site set for the prediction; rₙ is the reliability of the sample site, and the higher the similarity and reliability, the lower the predicted uncertainty value.

Compared with the prior art, the present disclosure provides a spatial prediction method of rice stable isotope based on environmental similarity, which uses the reliability of the sample site and the environmental similarity between the site to be predicted and the sample site to realize the spatial prediction of the site to be predicted. The environmental similarity is used to establish an effective prediction method. The case analysis shows that the method can improve the accuracy of the prediction result.

### BRIEF DESCRIPTION OF THE DRAWINGS

FIG. 1 is a spatial distribution diagram of sample sites in a study area according to the present disclosure; and

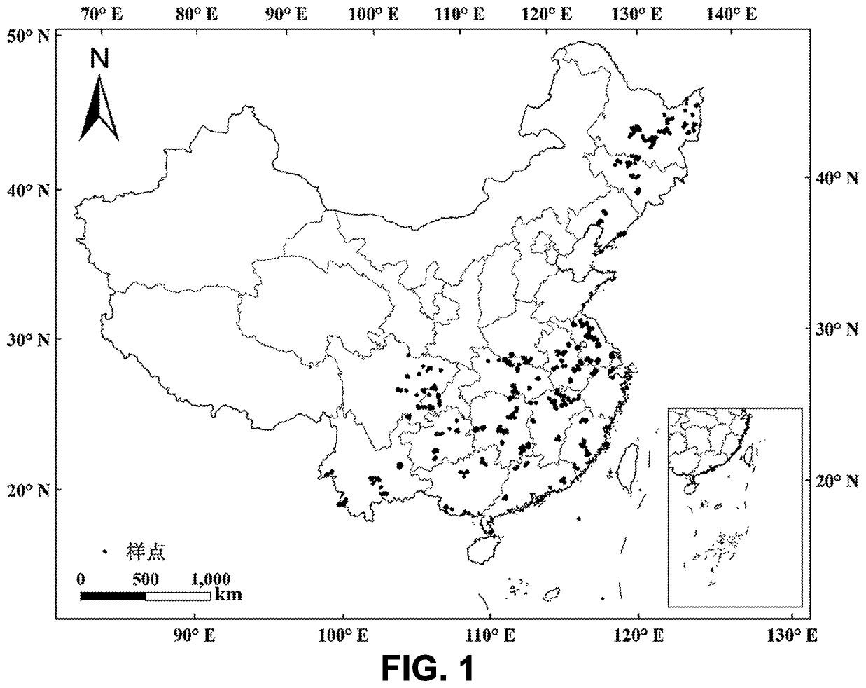

FIG. 2 is a flow chart of a spatial prediction method of rice stable isotope based on environmental similarity according to the present disclosure.

### DETAILED DESCRIPTION OF THE EMBODIMENTS

In order to make the content of the present disclosure more readily understandable, the content of the present disclosure will be described in detail in conjunction with specific embodiments and drawings hereinafter.

According to the third law of geography that “the more similar the geographic configurations of two points(areas), the more similar the values (processes) of the target variable at these two points (areas)”, the more similar the site of the geographical environment is, the closer the rice stable isotope value is. Based on this theory, the spatial distribution of rice stable isotope is predicted according to the similarity between two sites.

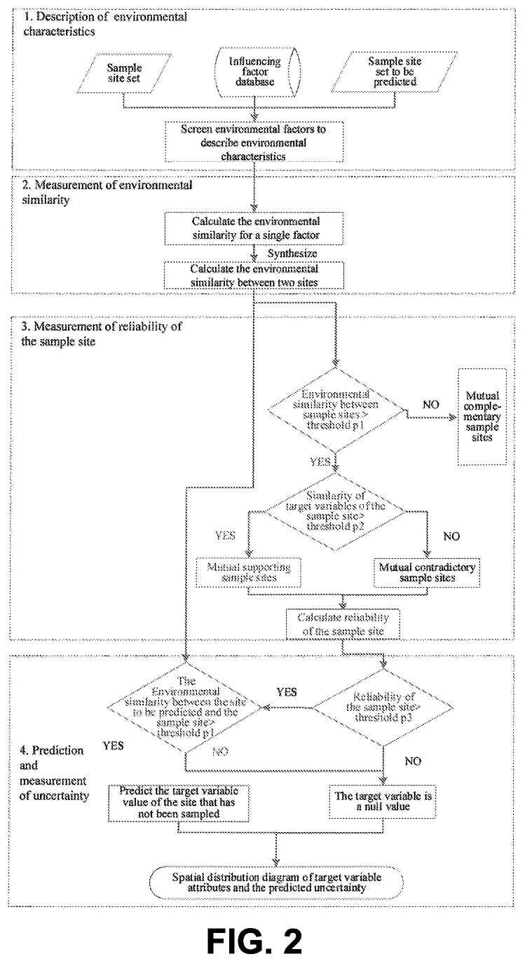

As shown in FIG. 2, the steps of the present disclosure are as follows.
(1) The environmental characteristics of rice stable isotope are described.

Correlation analysis is used to screen the factors having high correlation with rice stable isotope (δ¹³C, δ²H and δ¹⁸O) as auxiliary variables in the prediction process, forming an influencing factor database.
(2) Environmental similarity between a site to be predicted and a sample site is measured.

A similarity for single factor between the site to be predicted and the sample site is calculated using a Gower similarity calculation method, and the similarity for each influencing factor is synthesized by using a weighted average method to obtain a value of the environmental similarity between the site to be predicted and the sample site.

The Gower similarity calculation method is expressed as:

$$E ( {e}_{vi} , {e}_{vj} ) = 1 - \frac{\vert {e}_{vi} - {e}_{vj} \vert}{Range ( v )} ,$$

where E(·) is a function used to calculate the similarity of a single environmental variable; eᵥᵢ and eᵥⱼ are the characteristics of the v-th environmental variable at site i and site j, respectively; and Range (v) represents the range of the v-th environment variable.

The environmental similarity between the site to be predicted and the sample site is synthesized by using the weighted average method, and the calculation formula is as follows:

$${S}_{ij} = \frac{a * E ( {e}_{1 i} , {e}_{1 j} ) + b * E ( {e}_{2 i} , {e}_{2 j} ) + , … , + n * E ( {e}_{mi} , {e}_{mj} )}{a + b + … + n} ,$$

where Sᵢⱼ is the environmental similarity between site i and site j, and a, b . . . n are the weights of various environmental factors and eᵥᵢ and eᵥⱼ are the characteristics of the v-th environmental variable at site i and site), respectively.
(3) Reliability of the sample site is measured.

The reliability of the sample site is calculated by using the environmental similarity between the sample sites and the similarity for target variables. The relationship between the sample sites is determined according to the environmental similarity between the sample sites and the similarity for target variables. The more supporting sample sites are, the higher the reliability is: the more contradictory sample sites are, the lower the reliability is; if the sample site has only contradictory sample sites but no supporting sample sites, the reliability of the site is 0; and if there is neither a supporting sample site nor a contradiction site, the reliability of the site is unknown, which is set to a null value “NoData”. The calculation formula of the reliability of the sample site is as follows:

$${r}_{i} = \{ \begin{matrix}\frac{{\sum }_{k = 1}^{{n}_{s}} {TS}_{i , k}}{{n}_{s}} \times \frac{{n}_{s}}{{n}_{s} + {n}_{c}} , {n}_{s} + {n}_{c} > 0 and {n}_{s} \neq 0 \\ 0 , {n}_{c} > 0 and {n}_{s} = 0 \\ NoData , {n}_{s} + {n}_{c} = 0\end{matrix} ,$$

where rᵢ refers to the reliability of sample site i; nₛ and n_{c} represent for sample site i, the number of supporting sample sites and the number of contradictory sample sites, respectively; TS_{i,k} is based on the similarity for the target variable between the sample site i and the supporting sample site.
(4) Spatial prediction is carried out on the rice stable isotope according to the environmental similarity between the site to be predicted and the sample site and the reliability of the sample site.

The value of each site to be predicted is calculated by using the weighted average method, and the formula is as follows:

$${V}_{j} = \frac{{\sum }_{i = 1}^{{n}^{′}} {S}_{ji} \times {V}_{i}}{{\sum }_{i = 1}^{{n}^{′}} {S}_{ji}} ,$$

where n′ is the number of sample sites satisfying the prediction condition, and Sⱼᵢ is the environmental similarity between the site to be predicted j and the sample site i; and Vᵢ is the target variable value of sample site a (the stable isotope value).

The calculation formula of the uncertainty of the prediction is as follows:

Uⱼ=1−max(Sⱼ₁×r₁,Sⱼ₂×r₂, . . . ,Sⱼₙ×rₙ),

where n is the number of sample sites, and Sⱼₙ is the environmental similarity of a sample site set for the prediction; rₙ is the reliability of the sample site, and the higher the similarity and reliability is, the lower the uncertainty value of the prediction is.

The effectiveness of the method used by the present disclosure is analyzed.

A cross-validation method is used, 70% of the sample sites are randomly selected as a training sample site set, and the remaining 30% are used as a verification sample site set. Circulation is carried out for ten times. The results of prediction are evaluated and analyzed. Subsequently, the evaluation of spatial prediction of stable isotope is realized by comparing with the existing regression-Kriging method.

With reference to the flow chart shown in FIG. 2; the specific implementation method of the present disclosure will be explained by taking the stable isotope (δ¹³C, δ²H and δ¹⁸O) in the main rice producing areas in China as an example.

The study area is the main rice producing area in China. There are 794 sampling sites in the study area. The sampling was performed in 2017, involving 117 counties (cities or districts) in 17 provinces. The target variables of the prediction are stable carbon isotope, oxygen isotope and hydrogen isotope (δ¹³C, δ²H and δ¹⁸O), which are detected by isotope mass spectrometer (Isoprime 100, isoprime UK Ltd.). The spatial resolution of the prediction is 0.15°×0.15°.

According to the existing research results of stable isotope influencing factors, the present disclosure selects 10 influencing factors in 2017, including average annual temperature, average annual relative humidity, annual precipitation, annual sunshine hours, annual accumulated temperature (>10° C.), average temperature in the growing season (June to October), average relative humidity in the growing season, precipitation in the growing season, sunshine hours in the growing season and accumulated temperature in the growing season (>0.10′C), so as to establish an influencing factor database, and then the correlation between each factor and the stable isotope is analyzed. The significantly correlated factor (p<0.01) is selected as the auxiliary variable in the prediction. For the prediction of δ¹³C and δ¹⁸O, these 10 influencing factors are all significantly correlated, so that they are all used as auxiliary variables for prediction. For δ²H, in addition to the average temperature in the growing season and the accumulated temperature in the growing season, other factors are used as auxiliary factors for δ²H spatial prediction.

From the set of 794 sample sites, 555 (70%) sample sites are randomly selected as a training sample site set, and 239 (30%) sample sites are selected as a verification sample site set. The prediction model is established by using the training sample site set, and the verification sample site set is used to test and evaluate the prediction result of the model. Circulation is carried out for ten times in sequence.

The environmental similarity is calculated according to the prediction step 2. The reliability of the sample sites is calculated according to the prediction step 3. Finally, the sample sites are screened according to the environmental similarity and the reliability of the sample sites based on step 4, and then the sample site value of the sites to be predicted and the uncertainty of the prediction are calculated. The prediction average accuracies of δ¹³C, δ²H and δ¹⁸O are 0.51‰, 7.09‰ and 2.06‰, respectively. The average accuracies of δ¹³C, δ²H and δ¹⁸O predicted with the regression-geostatistical method are 0.54‰, 8.83‰ and 2.11‰, respectively. Generally speaking, the method of the present disclosure is more accurate in prediction than the regression-geostatistical method.

The spatial distribution diagram of δ¹³C, δ²H and δ¹⁸O of rice in China is obtained by the present disclosure, and the spatial distribution diagram of predicted uncertainty can also be obtained. The subsequent sampling can be landed according to the uncertainty of the prediction. More sampling sites can be set in areas with higher uncertainty, and fewer sampling sites can be set in areas with lower uncertainty, so that the sampling sites can be planned reasonably and the cost can be saved.

It can be understood that although the present disclosure has been disclosed in terms of preferred embodiments, the above embodiments are not intended to limit the present disclosure. For those skilled in the art, many possible changes and modifications can be made to the technical solution of the present disclosure by using the technical contents disclosed above, or the technical solution can be modified into equivalent embodiments with equivalent changes without departing from the scope of the technical solution of the present disclosure. Therefore, any simple modification, equivalent change and modification made to the above embodiment according to the technical essence of the present disclosure without departing from the content of the technical solution of the present disclosure still belongs to the scope of protection of the technical solution of the present disclosure.

1. A spatial prediction method of rice stable isotope based on environmental similarity, comprising:
(1) describing environmental characteristics of the rice stable isotope, and screening factors that have great influence on the rice stable isotope as auxiliary variables in prediction process;
(2) measuring an environmental similarity between a site to be predicted and a sample site, wherein a similarity for a single factor between the site to be predicted and the sample site is calculated, and similarity for each influencing factor is synthesized by using a weighted average method to obtain a value of the environmental similarity between the site to be predicted and the sample site;
(3) measuring a reliability of the sample site, wherein the reliability of the sample site is calculated by using an environmental similarity between sample sites and a similarity for a target variable; and
(4) carrying out a spatial prediction on the rice stable isotope according to the environmental similarity between the site to be predicted and the sample site and the reliability of the sample site.

2. The spatial prediction method according to claim 1, wherein step (2) comprises: calculating the environmental similarity for the single factor by using a Gower similarity calculation method, which is expressed as:
$$E ( {e}_{vi} , {e}_{vj} ) = 1 - \frac{\vert {e}_{vi} - {e}_{vj} \vert}{Range ( v )} ,$$
wherein E(·) is a function used to calculate a similarity of a single environmental variable; eᵥᵢ and eᵥⱼ are characteristics of a v-th environmental variable at site i and site j, respectively; and Range(v) represents a range of the v-th environment variable.

3. The spatial prediction method according to claim 2, wherein the environmental similarity between the site to be predicted and the sample site is synthesized by using the weighted average method, and a calculation formula is as follows:
$${S}_{ij} = \frac{a * E ( {e}_{1 i} , {e}_{1 j} ) + b * E ( {e}_{2 i} , {e}_{2 j} ) + , … , + n * E ( {e}_{mi} , {e}_{mj} )}{a + b + … + n} ,$$
wherein Sᵢⱼ is an environmental similarity between site i and site j, and a, b . . . n are the weights of various environmental factors; and eᵥᵢ and eᵥⱼ are the characteristics of the v-th environmental variable at site i and site j, respectively.

4. The spatial prediction method according to claim 1, wherein in step (3), the environmental similarity between the sample sites and the similarity for the target variable are calculated, and a threshold parameter (p₁) of the environmental similarity and a threshold parameter (p₂) of the similarity for the target variable are set, and the relationship between the sample sites is determined.

5. The spatial prediction method according to claim 4, wherein as supporting sample sites increase, the reliability increases; as contradictory sample sites increases, the reliability reduces; if the sample site has only a contradictory sample site but no a supporting sample site, the reliability of the sample site is 0; and if there is neither a supporting sample site nor a contradiction site, the reliability of the sample site is unknown, which is set to a null value “NoData”.

6. The spatial prediction method according to claim 5, wherein a calculation formula of the reliability of the sample site is as follows:
$${r}_{i} = \{ \begin{matrix}\frac{{\sum }_{k = 1}^{{n}_{s}} {TS}_{i , k}}{{n}_{s}} \times \frac{{n}_{s}}{{n}_{s} + {n}_{c}} , {n}_{s} + {n}_{c} > 0 and {n}_{s} \neq 0 \\ 0 , {n}_{c} > 0 and {n}_{s} = 0 \\ NoData , {n}_{s} + {n}_{c} = 0\end{matrix} ,$$
wherein rᵢ refers to a reliability of a sample site i; nₛ and n_{c} represent a number of supporting sample sites and a number of contradictory sample sites for the sample site i, respectively; TS_{i,k} is based on the similarity for the target variable between the sample site i and the supporting sample site.

7. The spatial prediction method according to claim 1, wherein in step (4), calculating a stable isotope value of the site to be predicted based on steps (2) and (3) comprises: calculating a value of each site to be predicted by using the weighted average method, and a formula is as follows:
$${V}_{j} = \frac{{\sum }_{i = 1}^{{n}^{′}} {S}_{ji} \times {V}_{i}}{{\sum }_{i = 1}^{{n}^{′}} {S}_{ji}} ,$$
wherein n′ is a number of sample sites satisfying a prediction condition, and Sⱼᵢ is an environmental similarity between a site to be predicted j and a sample site i; and Vᵢ is a target variable value of the sample site i, that is, the stable isotope value.

8. The spatial prediction method according to claim 7, wherein a calculation formula of an uncertainty of the prediction is as follows:
Uⱼ=1−max(Sⱼ₁×r₁,Sⱼ₂×r₂, . . . ,Sⱼₙ×rₙ),
wherein n is a number of sample sites, and Sⱼₙ is an environmental similarity of a sample site set for the prediction; rₙ is the reliability of the sample site, and as the similarity and the reliability increases, the uncertainty value of the prediction reduces.

9. The spatial prediction method according to claim 1, wherein the environmental similarity between the site to be predicted and the sample site is synthesized by using the weighted average method, and a calculation formula is as follows:
$${S}_{ij} = \frac{a * E ( {e}_{1 i} , {e}_{1 j} ) + b * E ( {e}_{2 i} , {e}_{2 j} ) + , … , + n * E ( {e}_{mi} , {e}_{mj} )}{a + b + … + n} ,$$
wherein S_ij is an environmental similarity between site i and site j, and a, b . . . n are the weights of various environmental factors; and evi and evj are the characteristics of the v-th environmental variable at site i and site j, respectively.
